(19) United States
(12) Patent Application Publication
(10) Pub. No.: US 2025/0086432 A1
(43) Pub. Date: Mar. 13, 2025

(54) MODIFIED INPUTS FOR ARTIFICIAL INTELLIGENCE MODELS

(71) Applicant: Capital One Services, LLC, McLean, VA (US)

(72) Inventor: Baris BILEK, Leesburg, VA (US)

(21) Appl. No.: 18/466,515

(22) Filed: Sep. 13, 2023

(51) Int. Cl. G06N 3/0455; G06N 3/08

(52) U.S. Cl. CPC G06N 3/0455; G06N 3/08

(57) ABSTRACT

In some implementations, a device may receive an input for the artificial intelligence model, wherein the input describes an output of the artificial intelligence model. The device may generate, via the artificial intelligence model, the output based on a modified input that is based on modifying one or more keywords included in the input to be indicative of respective entities based on the one or more keywords being associated with respective entity parameters. The device may provide, based on receiving the input, the output for display, wherein the output includes visual elements, associated with respective keywords of the one or more keywords, that indicate the respective entities.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for modifying inputs for an artificial intelligence model. The system may include one or more memories and one or more processors communicatively coupled to the one or more memories. The one or more processors may be configured to receive, via a user device, an input requesting a visual media output. The one or more processors may be configured to determine one or more keywords included in the input. The one or more processors may be configured to identify, for at least one keyword of the one or more keywords, an association between the at least one keyword and an entity parameter, wherein the entity parameter is indicative of an entity. The one or more processors may be configured to modify, based on the association, the input to create a modified input, wherein the modified input includes a modification to the at least one keyword to cause the at least one keyword to be indicative of the entity. The one or more processors may be configured to provide, to the artificial intelligence model, the modified input. The one or more processors may be configured to obtain, via the artificial intelligence model and based on providing the modified input, the visual media output. The one or more processors may be configured to provide, to the user device, the visual media output for display.

Some implementations described herein relate to a method of modifying inputs for an artificial intelligence model. The method may include receiving, by a device, an input for the artificial intelligence model, wherein the input describes an output of the artificial intelligence model. The method may include generating, by the device and via the artificial intelligence model, the output based on a modified input that is based on modifying one or more keywords included in the input to be indicative of respective entities based on the one or more keywords being associated with respective entity parameters. The method may include providing, by the device and based on receiving the input, the output for display, wherein the output includes visual elements, associated with respective keywords of the one or more keywords, that indicate the respective entities.

Some implementations described herein relate to a non-transitory computer-readable medium that stores a set of instructions. The set of instructions, when executed by one or more processors of a device, may cause the device to receive an input requesting a visual media output. The set of instructions, when executed by one or more processors of the device, may cause the device to determine one or more keywords included in the input. The set of instructions, when executed by one or more processors of the device, may cause the device to identify, for at least one keyword of the one or more keywords, an association between the at least one keyword and an entity parameter, wherein the entity parameter is indicative of an entity. The set of instructions, when executed by one or more processors of the device, may cause the device to modify, based on the association, the input to a modified input, wherein the modified input includes a modification to the at least one keyword to cause the at least one keyword to be indicative of the entity. The set of instructions, when executed by one or more processors of the device, may cause the device to provide, to an artificial intelligence model, the modified input. The set of instructions, when executed by one or more processors of the device, may cause the device to obtain, via the artificial intelligence model and based on providing the modified input, the visual media output. The set of instructions, when executed by one or more processors of the device, may cause the device to provide the visual media output for display.

### BRIEF DESCRIPTION OF THE DRAWINGS

FIGS. 1A-1C are diagrams of an example associated with modified inputs for artificial intelligence models, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with modified inputs for artificial intelligence models, in accordance with some embodiments of the present disclosure.

FIG. 4 is a flowchart of an example process associated with modified inputs for artificial intelligence models, in accordance with some embodiments of the present disclosure.

### DETAILED DESCRIPTION

The following detailed description of example implementations refers to the accompanying drawings. The same reference numbers in different drawings may identify the same or similar elements.

In some examples, artificial intelligence (AI) and/or machine learning techniques may be used for visual content (e.g., images, video, and/or other visual content) generation. For example, an AI model may include a generative model that is trained to output visual content based on an input (e.g., a text input). The AI model may integrate natural language processing (NLP) techniques with computer vision and/or image synthesis techniques to perform text-to-visual content generation. For example, the AI model may perform operation(s) associated with text understanding, embedding generation, keyword identification, and/or image synthesis, among other examples.

For example, the AI model may analyze an input (e.g., a text input) using a transformer-based architecture to encode and represent the semantic meaning of the input text. The AI model may generate embeddings that capture the contextual relationships between words and phrases in the text. The AI model may identify keywords or other relevant information from the text input. For example, the AI model may identify keywords that may guide the image synthesis process by indicating which aspects of the text should be represented visually. For example, the AI model may utilize named entity recognition (NER) and/or part-of-speech tagging to extract important entities, nouns, and/or descriptive phrases, among other examples from the text.

The AI model may include a shared embedding space for both text and images. The shared embedding space may be shared for both text and visual content (e.g., images and/or videos). The shared embedding space may be trained to align embeddings from corresponding text-visual content pairs. This alignment allows textual descriptions and visual content to share a common representation, enabling seamless interaction between the two modalities. After the text is encoded and keywords are identified, the AI model may perform an image generation operation, such as by using a conditional generative model (e.g., a generative adversarial network (GAN), a variational autoencoder (VAE), or another model trained to generate visual content). For example, the AI model may use, as an input, the textual embedding and keywords to produce images that align with the description indicated by the text input. The keywords identified in the input may guide the image generation process, ensuring that relevant visual attributes and objects are included in the generated image. In some examples, the AI model may utilize one or more attention mechanisms to enable the AI model to selectively focus on different parts of the input while generating an output, enhancing the ability of the AI model to capture relationships and dependencies in the input. For example, when generating an image from textual descriptions, the one or more attention mechanisms may facilitate a determination of which words or phrases in the input are most relevant to the image generation operation. By assigning attention weights to different words or tokens in the input, the AI model can prioritize the information that should be represented in the generated visual content.

However, generating a relevant output for a user based on the input may be difficult. For example, the input may include a generic description of a desired output. The description may lack the specificity required to generate detailed or tailored outputs (e.g., an input of “a vehicle” may result in an output generally depicting a vehicle, rather than a specific type of vehicle with distinct characteristics intended by the user providing the input). Further, the shared embedding space in the AI model and/or the multi-modal tasks (e.g., for integrating multiple modalities, such as text and image or text and video) may result in challenges associated with generating relevant outputs for given text inputs because the AI model relies on mappings in the embedding space to combine information from the different modalities. Ensuring that the shared embedding space accurately maps text to visual content to generate relevant outputs for a particular user or a particular input may be difficult.

For example, an output that may be relevant to a first user may not be relevant to a second user (e.g., even if the first user and the second user provide the same input). Additionally, an output that may be relevant to a first input (e.g., based on a first context of the first input) may not be relevant to a second input (e.g., based on a second context of the second input), even if the first input and the second input include the same textual description. Further, because of the complex mappings and associations in the shared embedding space of the AI model, it may be difficult for a user to craft an input that will result in a desired relevant output. For example, the user may not know which keywords will cause the AI model to produce the desired output. As a result, the AI model may produce one or more outputs that are not relevant to the input and/or the user that provides the input. This may consume processing resources, memory resources, computing resources, network resources, and/or power resources, among other examples, associated with obtaining the input, processing the input, generating the irrelevant output, and providing the irrelevant output for display. Further, this may result in the user providing an additional input in an attempt to obtain a more relevant output, thereby consuming processing resources, memory resources, computing resources, network resources, and/or power resources, among other examples, associated with generating the additional input, providing the additional input to the AI model, and/or generating an output based on the additional input.

Some implementations described herein enable modified inputs for an AI model to cause the AI model to produce enhanced outputs with improved relevancy. For example, a model management device may receive an input requesting (e.g., describing) a visual media output. The input may be a textual input that includes one or more words describing the visual media output that is requested. The model management device may determine one or more keywords included in the input. The model management device may identify, one or more keywords, an association between the at least one keyword and a modification parameter. For example, the modification parameter may be a parameter indicating that the keyword is to be modified. In some implementations, the modification parameter may be based on a context of the input, such as other keywords included in the input, a type or category associated with the input, and/or metadata associated with the input, among other examples.

As an example, the modification parameter may include an entity parameter. The entity parameter may be indicative of an entity (e.g., a brand). For example, the entity parameter may indicate that there is an association or mapping between the entity and one or more keywords (or phrases). The model management device may modify, based on the association and/or the modification parameter, the input to create a modified input. For example, the modified input may include a modification to a keyword to cause the keyword to be indicative of the entity indicated by the entity parameter. For example, the model management device may modify one or more keywords included in the input to cause the input to provide more relevant information for an AI model to enable the AI model to generate a more relevant output (e.g., where the modification may be based on a keyword association training of an embedding space of an AI model).

The model management device may provide, to an AI model (e.g., that is trained to generate a visual content output based on a text input), the modified input. The model management device may obtain, via the artificial intelligence model and based on providing the modified input, a visual media output. The model management device may provide the visual media output for display.

As a result, by modifying the input, the model management device may cause the AI model to generate a visual media output with improved relevancy for the input and/or a user associated with the input. This may conserve processing resources, memory resources, computing resources, network resources, and/or power resources, among other examples, that would have otherwise been used to obtain the input, process the input, generate a less relevant output, and provide the less relevant output for display. Additionally, this may reduce a likelihood of repeated and/or additional inputs that may otherwise occur if the AI model generates the less relevant outputs, thereby conserving processing resources, memory resources, computing resources, network resources, and/or power resources, among other examples, that would have otherwise been used in associated with the repeated and/or additional inputs.

Further, by modifying the input and providing the modified input to the AI model, a complexity associated with generating visual media outputs with improved relevancy may be reduced. For example, by modifying the input based on a keyword association training of an embedding space of the AI model, the relevancy of the generated visual media output may be improved without re-training and/or modifying the shared embedding space of the AI model. This may conserve processing resources, memory resources, computing resources, network resources, and/or power resources, among other examples, that would have otherwise been used to re-train and/or modify the shared embedding space of the AI model.

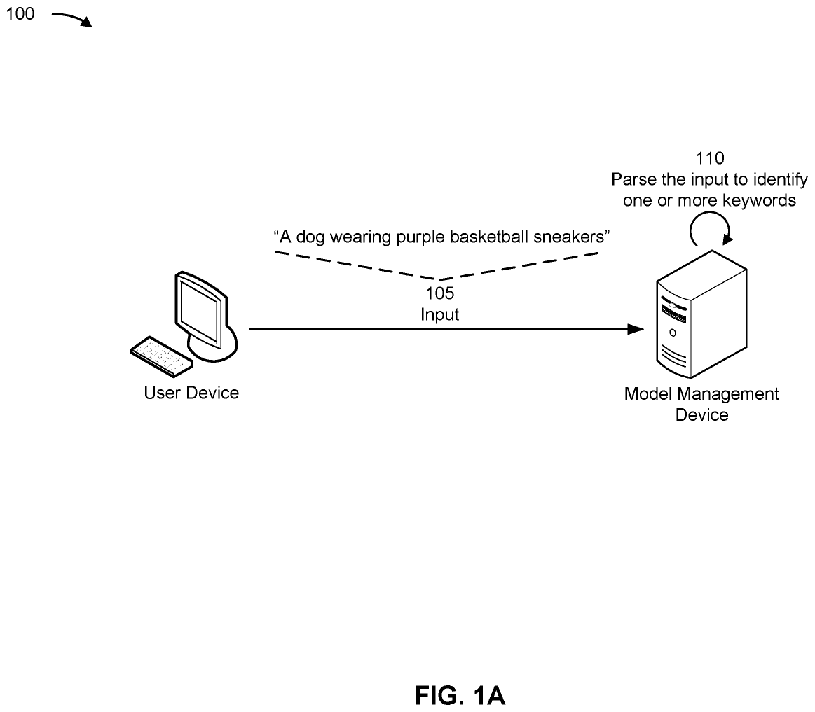

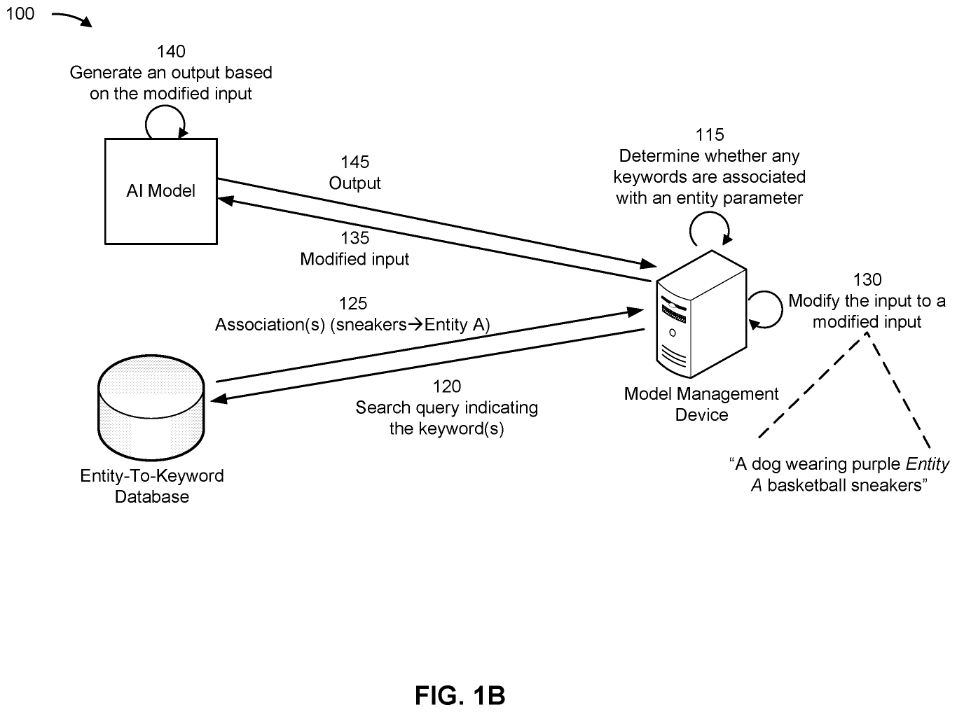

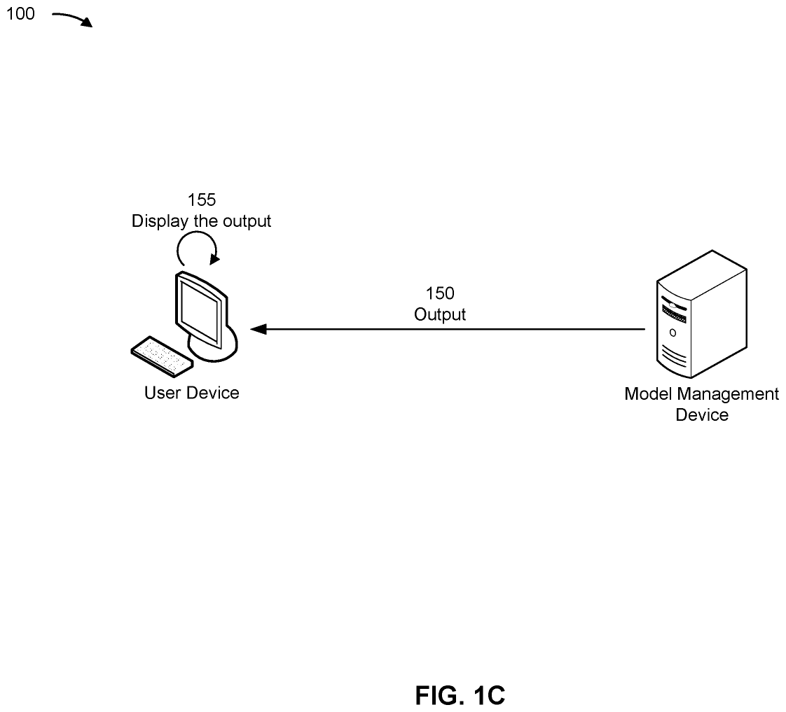

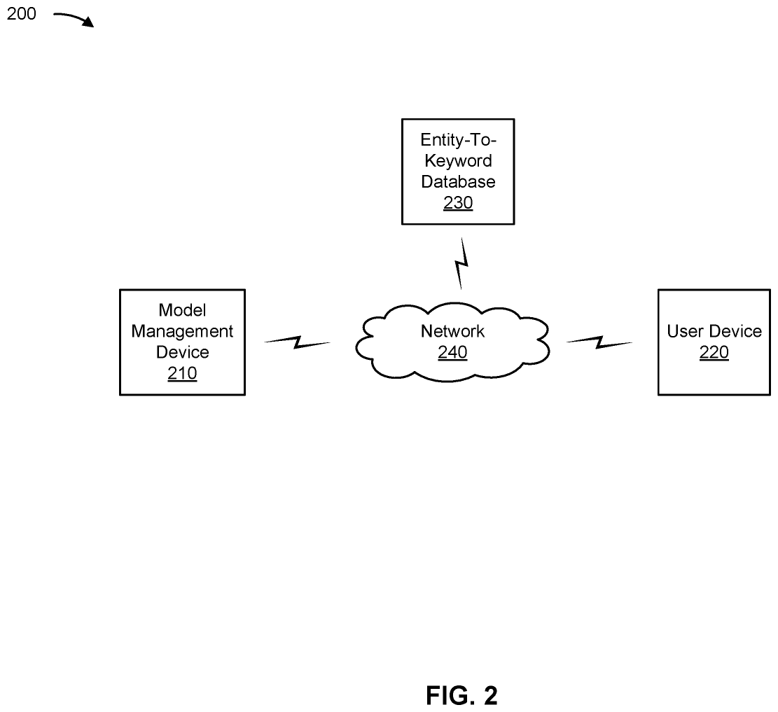

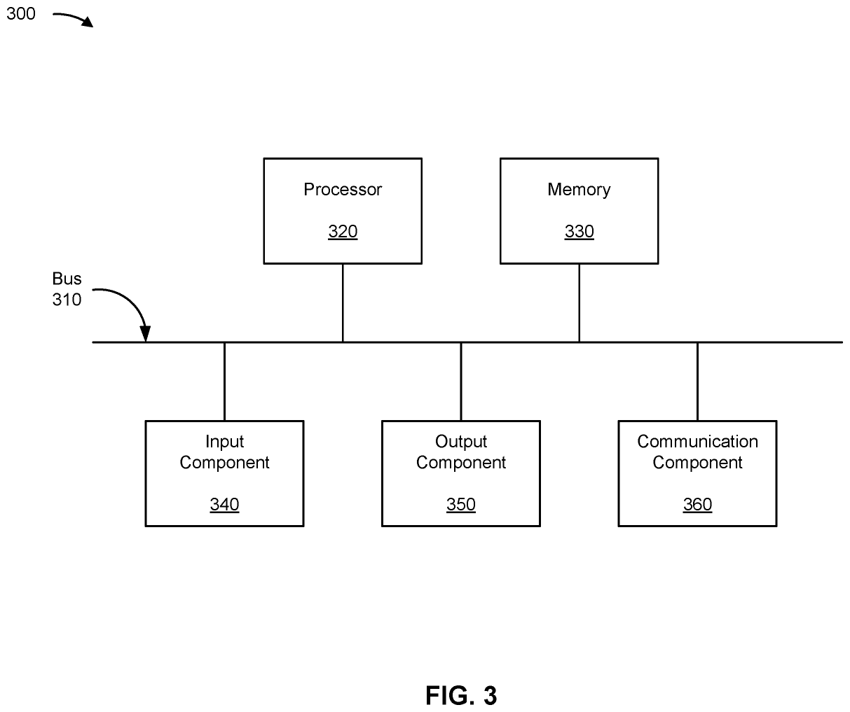

FIGS. 1A-1C are diagrams of an example 100 associated with modified inputs for artificial intelligence models. As shown in FIGS. 1A-1C, example 100 includes a model management device associated with an AI model, a user device, and an entity-to-keyword database. These devices are described in more detail in connection with FIGS. 2 and 3.

Some examples are described herein in association with an AI model that is trained and/or configured to generate visual content outputs (e.g., text-to-image models or text-to-video models). For example, the AI model may be similar to the AI model described above. However, the implementations described herein may be similarly applied to other types of AI models and/or machine learning models to facilitate enhanced outputs of the AI models and/or machine learning models.

As shown in FIG. 1A, and by reference number 105, the user device may transmit, and the model management device may receive, an input. For example, the user device may obtain the input. The user device may obtain the input via a user input. For example, the user device may display a user interface associated with a platform that is managed by the model management device. The platform may be associated with the AI model. For example, the platform may be an AI-based generative platform that is configured to provide visual content outputs that are based on text-based inputs.

The input may request a visual media output. For example, the input may include one or more words or phrases describing the visual media output that is requested. As an example, as shown in FIG. 1A, the input may be “a dog wearing purple basketball sneakers.” In such examples, the requested visual media output may be an image of a dog wearing purple basketball sneakers.

As shown by reference number 110, the model management device may parse the input to identify one or more keywords included in the input. For example, the model management device may determine one or more keywords included in the input. The model management device may perform one or more NLP operations to determine the one or more keywords. For example, the model management device may perform one or more text pre-processing operations, such as tokenizing the input into individual words or sub-words, performing named entity recognition, and/or performing part-of-speech tagging, among other examples. The model management device may generate numerical representations for respective words included in the input. The numerical representations may include embeddings. For example, the embeddings may represent or capture the semantic meaning and/or contextual relationships between words included in the input. The model management device may analyze the numerical representations (e.g., the embeddings) to identify words or phrases associated with significant semantic meanings for the input. For example, the model management device may use one or more attention operations, self-attention, aggregation, and/or other operations to extract features that contribute to the overall understanding of the text included in the input.

For example, the model management device may generate sematic relevancy scores for respective words (or embeddings) associated with the input. A semantic relevancy score may indicate an importance level of a word for representing the semantic meaning of the input. The model management device may determine the one or more keywords based on the semantic relevancy scores. For example, the one or more keywords may be words included in the input that are associated with semantic relevancy scores that satisfy a relevancy threshold.

As an example, for the input of “a dog wearing purple basketball sneakers,” the one or more keywords may include dog, purple, basketball, sneakers, and/or basketball sneakers, among other examples. As another example, for an input of “generate an image of a girl in front of a post office,” the one or more keywords may include girl, front, and/or post office, among other examples. The one or more keywords may be the most important words in the input that provide an indication of the output requested by the input.

As shown in FIG. 1B, and by reference number 115, the model management device may determine whether any keywords (e.g., included in the input) are associated with an entity parameter. The entity parameter may be an example of a modification parameter. An entity parameter may be indicative of an entity. For example, an entity parameter may indicate that a keyword is associated with a given entity (e.g., a brand, a company, an institution, or another entity). For example, the entity-to-keyword database may store mappings between words or phrases (e.g., keywords) and entity parameters.

For example, as shown by reference number 120, the model management device may transmit, and the entity-to-keyword database may receive, a search query indicating the one or more keywords. For example, the model management device may search, using the one or more keywords, an entity database (e.g., the entity-to-keyword database) to identify the entity parameter. As shown by reference number 125, the entity-to-parameter database may transmit, and the model management device may receive, an indication of one or more associations between keywords and entity parameters. For example, as shown in FIG. 1B, the model management device may obtain an indication that the keyword “sneakers” is associated with, or mapped to, an entity parameter associated with an Entity A.

In some implementations, the model management device may determine a category associated with a keyword. In such examples, the association may be between the category and the entity parameter. For example, an input may indicate a keyword included in a category. The model management device may determine the category. The model management device may search the entity-to-keyword database using the category. The model management device may determine if the keyword is associated with an entity parameter based on whether the category is associated with an entity parameter (e.g., as indicated by one or more entries in the entity-to-keyword database).

In some implementations, the model management device may determine, for a keyword, a set of entity parameters associated with the keyword. For example, the entity-to-keyword database may include an indication that a given keyword is associated with multiple entity parameters. The model management device may determine entity scores for respective entity parameters from the set of entity parameters. An entity score may be based on information stored in the entity-to-keyword database and/or may be based on the input. For example, the entity score may be indicated by an entry in the entity-to-keyword database. As an example, an entity score may indicate a bid amount that is associated with the entity.

As another example, the entity score may indicate an engagement level associated with historical outputs that were modified to indicate the entity. For example, the engagement level may be based on engagements (e.g., clicks, shares, downloads, and/or other engagement) with the historical outputs. If the historical outputs have more engagements, then the engagement level may indicate a higher level of engagement (e.g., and the entity score may be higher). If the historical outputs have less engagements, then the engagement level may indicate a lower level of engagement (e.g., and the entity score may be lower). As another example, the entity score may be based on one or more other keywords included in the input. For example, the model management device may determine the entity scores. For example, certain entities may be more relevant for a given keyword when used in connection with certain other keywords. For example, the one or more other keywords may be modifiers of the keyword that is mapped to or associated with the entity parameter. As an example, the entity score may indicate a relevancy level for a given entity in connection with the other keyword(s) included in the input.

The model management device may determine that the keyword is associated with the entity parameter based on an entity score associated with the entity parameter being a highest entity score among the entity scores of the set of entity parameters. For example, where multiple entity parameters are associated with a given keyword, the model management device may determine a given entity parameter, from the multiple entity parameters, based on the entity scores (e.g., the model management device may select the entity parameter associated with the highest entity score).

The model management device may identify one or more keywords (e.g., to be modified) from the set of keywords based on the one or more keywords being associated with respective entity parameters. For example, if the model management device determines that a keyword is associated with an entity parameter, then the model management device may determine that the keyword is to be modified to indicate the entity associated with the entity parameter.

As shown by reference number 130, the model management device may modify the input to a modified input. For example, the model management device may modify, based on the association of the entity parameter, the input to create a modified input. The modified input may include a modification to one or more keywords to cause the one or more keywords to be indicative of respective entities. For example, the model management device may modify a keyword to be indicative of an entity (e.g., associated with an entity parameter) that is indicated as being, and/or determined to be, associated with the keyword. As an example, as shown in FIG. 1B, the modified input may be “a dog wearing purple Entity A basketball sneakers” because the keyword of “sneakers” may be associated with an entity parameter associated with the Entity A.

In some implementations, the model management device may determine whether to modify a given keyword. For example, the model management device may determine whether the keyword is modified by a modifier in the original input. For example, the keyword may be modified by a modifier that is associated with an identified modification parameter. As an example, where the modification parameter is an entity parameter, the model management device may determine whether the keyword is modified by an entity modifier in the input. In other words, the model management device may determine whether the input includes an indication of a specific entity associated with the keyword. The model management device may identify the one or more keywords to be modified based on the one or more keywords not being modified by certain modifiers (e.g., entity modifiers) in the input. For example, if the input requests a specific modification to be associated with a keyword, then the model management device may refrain from modifying the keyword to indicate a different modification (e.g., a different entity that indicated by the input). This may ensure that the provided output is indicative or similar to what is requested by the input. As an example, if the input were “a dog wearing purple Entity B basketball sneakers,” then the model management device may refrain from modifying the keyword of “sneakers” to indicate Entity A (e.g., even if the keyword of “sneakers” is associated with an entity parameter associated with the Entity A, as described above).

The modification parameter may indicate different types of modifications to the input. The modification may be any modification to the input to cause the AI model to generate an output that has improved relevancy (e.g., to a given entity and/or to the user). For example, a modification parameter may include a location parameter. For example, the model management device may modify the input to be indicative of a given location. The model management device may determine the location based on an association and/or mapping to one or more keywords, in a similar manner as described above. Additionally, or alternatively, the model management device may determine the location based on information associated with the user device. For example, the model management device may receive location information indicative of a location of the user device (e.g., via an internet protocol (IP) address of the user device, global positioning system (GPS) information of the user device, or other location information). The model management device may modify the input to be indicative of the location of the user device. For example, if the input is “generate an image of a girl standing in front of a post office” and the location information indicates that the location of the user device is a “location A,” then the model management device may modify the input to be “generate an image of a girl standing in front of a post office located in location A.”

As another example, the modification parameter may include an hyponymy parameter. For example, a keyword may indicate a category or types of items. The hyponymy parameter may indicate a hyponym (e.g., a subordinate word) that is associated with a hypernym (e.g., a broader class or category). The identified keyword may be the hypernym (e.g., “car”) and the item parameter may indicate that the identified keyword is to be modified to a hyponym (e.g., a specific make, model, and/or year of car) of the hypernym. As another example, the identified keyword may be “snack food” and the hyponymy parameter may indicate that the keyword of “snack food” is associated with the hyponym of “Entity C chips.” In such examples, the model management device may replace the keyword of “snack food” with “Entity C chips” to generate the modified input.

In some implementations, the model management device may analyze the modified input to determine whether the semantic meaning of the modified input is the same as or similar to the input. For example, the model management device may determine, via a natural language processing operation, a first semantic meaning associated with the input (e.g., as indicated by a first one or more embeddings representing the input). The model management device may determine, via the natural language processing operation, a second semantic meaning associated with the input. For example, the model management device may determine a second one or more embeddings representing the modified input. The model management device may determine a similarity metric indicating a similarity between the first semantic meaning and the second semantic meaning.

In some implementations, the similarity metric may include a distance (e.g., in an embedding space) between the first one or more embeddings and the second one or more embeddings. The model management device may provide, to the AI model, the modified input based on the similarity metric satisfying a similarity threshold. In other words, if the similarity metric satisfies the similarity threshold (e.g., indicating that the first semantic meaning and the second semantic meaning are the same or similar), then the model management device may provide, to the AI model, the modified input. However, if the similarity metric does not satisfy the similarity threshold (e.g., indicating that the first semantic meaning and the second semantic meaning are different), then the model management device may refrain from providing, to the AI model, the modified input. In such examples, the model management device may provide the original input to the AI model or may determine a different modified input (e.g., as described above). This may ensure that the modified input represents a similar semantic meaning as the input provided to the model management device, thereby improving the likelihood that the output generated by the AI model will be relevant to the user that provided the original input.

As shown by reference number 135, the model management device may provide, and the AI model may obtain, the modified input. For example, rather than providing the input obtain from the user device to the AI model, the model management device may provide the modified input to the AI model to cause the AI model to generate an output (e.g., a visual content output) that is based on the modified input.

As shown by reference number 140, the AI model may generate an output based on the modified input. As shown by reference number 145, the AI model may provide, and the model management device may obtain, the output (e.g., the visual media output). For example, the AI model may generate a visual media output (e.g., one or more images and/or one or more videos) based on the modified input. For example, the visual media output may include one or more visual elements.

In some implementations, a visual element may be described by a keyword that was modified by the model management device, as described in more detail elsewhere herein. In such examples, the visual element may visually depict that the visual element is associated with a modification parameter. In some implementations, the output may include visual elements, associated with respective keywords of the one or more keywords that were modified, that indicate the respective entities associated with the one or more keywords. For example, the visual elements may be visually indicative of the respective entities. For example, if the modification parameter is an entity parameter (e.g., associated with an entity), then the visual element may visually indicate that the visual element is associated with the entity. Using the example modified input of “a dog wearing purple Entity A basketball sneakers,” the visual element may depict basketball sneakers. Based on modifying the input, rather than the visual element depicting generic basketball sneakers, the visual media output may depict basketball sneakers associated with the Entity A (e.g., that are provided by or offered for sale by the Entity A). As another example, if the input is “generate an image of a girl standing in front of a post office” and the modification parameter is a location parameter indicative of a location A, then the visual element may depict a specific post office that is located in the location A.

In some implementations, the operations described in connection with the reference number 115, the reference number 120, the reference number 125, and/or the reference number 130 may be performed by, or in connection with, the AI model. For example, the model management device may provide, and the AI model may obtain, one or more mappings between modification parameters and keywords. As an example, the model management device may provide, and the AI model may obtain, an indication of associations between keywords and entity parameters to train the artificial intelligence model to modify inputs based on the associations. In such example, the model management device may provide, and the AI model may obtain, the input and the AI model may modify the input as described herein (e.g., as described in connection with reference number 135). In such examples, the model management device may obtain, from the AI model, the output that is based on the modified input (e.g., as described in connection with reference number 145).

As shown in FIG. 1C, and by reference number 150, the model management device may provide the output (e.g., the visual media output) for display. For example, the model management device may transmit, and the user device may receive, the output for display. As shown by reference number 155, the user device may display the output. For example, the user device may display the visual media output (e.g., one or more generated images and/or video) for display via a user interface displayed by the user device. For example, the user interface may be associated with the platform via which the user device obtained the input, as described in more detail elsewhere herein.

In some implementations, the output (e.g., the visual media output) may include one or more selectable elements. A selectable element may be configured to cause a device (e.g., the user device) to navigate to a page, a webpage, and/or an application, among other examples, when selected. For example, the model management device may embed the output with one or more anchor tags (e.g., hypertext markup language (HTML) anchor tags) to define where the selectable element leads when selected via a user input. For example, an anchor tag may define a destination uniform resource locator (URL) address. If a user input indicates a selection of the selectable element, then the user device may navigate to the URL address defined by the anchor tag.

For example, the model management device may identify one or more visual elements in the output that are associated with a modification performed by the model management device, as described in more detail elsewhere herein. The model management device may cause the output to include selectable elements associated with one or more of the identified visual elements. Using the example of the modified input of “A dog wearing purple Entity A basketball sneakers,” the model management device may determine that the visual element is a visual element in the output depicting “Entity A basketball sneakers” (e.g., because the Entity A basketball sneakers is the portion of the input that has been modified by the model management device). The model management device may cause one or more selectable elements to be included in the output in connection with the visual element(s). For example, the selectable elements may cause the visual element(s) to be “selectable” via a user input. A selection of a selectable element and/or a visual element may cause the user device to navigate to a page, a webpage, and/or an application, among other examples, associated with the modification.

Using the example of the modified input of “A dog wearing purple Entity A basketball sneakers,” the model management device may insert a selectable element in the output in connection with a visual element depicted the basketball sneakers. The selectable element may be configured to cause a device (e.g., the user device) to navigate to a page, a webpage, and/or an application, among other examples, associated with the Entity A. For example, the selectable element may be configured to cause the user device to navigate to a location at which a user can purchase the basketball sneakers depicted in the output. By including one or more selectable elements in the output (e.g., the visual media output), an amount of navigation performed by a user may be reduced. For example, this may conserve processing resources, computing resources, and/or network resources that would have otherwise been used to navigate through a large number of web pages to find relevant information (e.g., to find a page associated with the modification depicted in the output). Furthermore, by including one or more selectable elements in the output (e.g., the visual media output), the model management device may improve a user experience, enhancing user-friendliness of a user device and a user interface, and improve the ability of a user to use the user device by making navigation to the location defined by a selectable element easier.

In some implementations, the model management device may cause the output to be provided (e.g., shared) via another platform, such as a social media platform (e.g., may cause the output to be automatically published via another platform, such as on a social media page, a web page, and/or another location). As another example, the model management device may cause a physical copy of the output to be generated. For example, the model management device may communicate with a printer (e.g., an inkjet printer or a 3D printer) to cause a physical copy of the output to be printed.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a model management device 210, a user device 220, an entity-to-keyword database 230, and a network 240. Devices of environment 200 may interconnect via wired connections, wireless connections, or a combination of wired and wireless connections.

The model management device 210 may include one or more devices capable of receiving, generating, storing, processing, providing, and/or routing information associated with modifying inputs for an artificial intelligence model, as described elsewhere herein. The model management device 210 may include a communication device and/or a computing device. For example, the model management device 210 may include a server, such as an application server, a client server, a web server, a database server, a host server, a proxy server, a virtual server (e.g., executing on computing hardware), or a server in a cloud computing system. In some implementations, the model management device 210 may include computing hardware used in a cloud computing environment.

The user device 220 may include one or more devices capable of receiving, generating, storing, processing, and/or providing information associated with modifying inputs for an artificial intelligence model, as described elsewhere herein. The user device 220 may include a communication device and/or a computing device. For example, the user device 220 may include a wireless communication device, a mobile phone, a user equipment, a laptop computer, a tablet computer, a desktop computer, a gaming console, a wearable communication device (e.g., a smart wristwatch, a pair of smart eyeglasses, a head mounted display, or a virtual reality headset), or a similar type of device.

The entity-to-keyword database 230 may include one or more devices capable of receiving, generating, storing, processing, and/or providing information associated with modifying inputs for an artificial intelligence model, as described elsewhere herein. The entity-to-keyword database 230 may include a communication device and/or a computing device. For example, the entity-to-keyword database 230 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the entity-to-keyword database 230 may store one or more entity parameters indicating associations between entities and respective keywords or phrases, as described elsewhere herein.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with modified inputs for artificial intelligence models. The device 300 may correspond to the model management device 210, the user device 220, and/or the entity-to-keyword database 230. In some implementations, the model management device 210, the user device 220, and/or the entity-to-keyword database 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

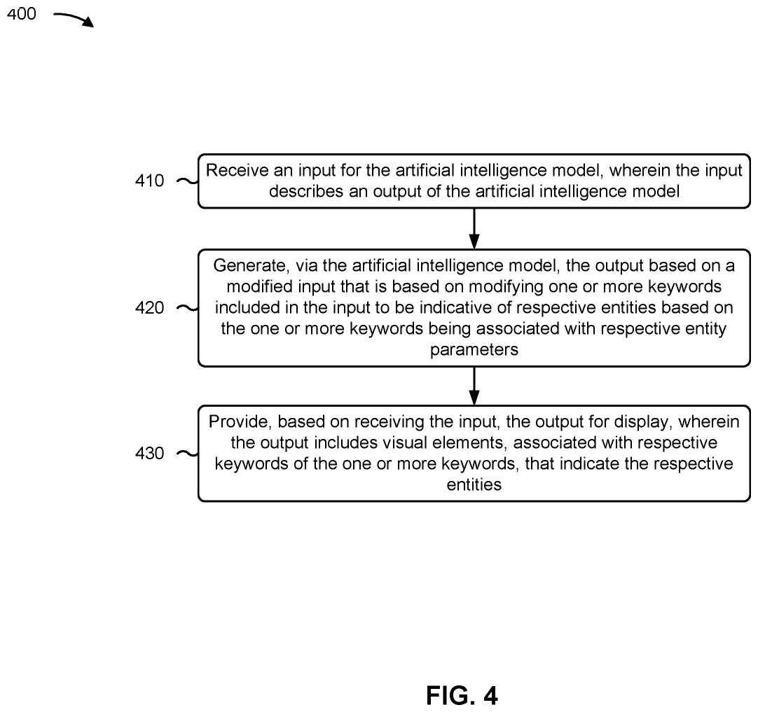

FIG. 4 is a flowchart of an example process 400 associated with modified inputs for artificial intelligence models. In some implementations, one or more process blocks of FIG. 4 may be performed by the model management device 210. In some implementations, one or more process blocks of FIG. 4 may be performed by another device or a group of devices separate from or including the model management device 210, such as the user device 220 and/or the entity-to-keyword database 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving an input for the artificial intelligence model (block 410). For example, the model management device 210 (e.g., using processor 320, memory 330, input component 340, and/or communication component 360) may receive an input for the artificial intelligence model, as described above in connection with reference number 105 of FIG. 1A. In some implementations, the input describes an output of the artificial intelligence model. As an example, the input may include one or more words or phrases described a requested output. The requested output may be a visual media output (e.g., one or more images and/or one or more videos).

As further shown in FIG. 4, process 400 may include generating, via the artificial intelligence model, the output based on a modified input that is based on modifying one or more keywords included in the input to be indicative of respective entities based on the one or more keywords being associated with respective entity parameters (block 420). For example, the model management device 210 (e.g., using processor 320 and/or memory 330) may generate, via the artificial intelligence model, the output based on a modified input that is based on modifying one or more keywords included in the input to be indicative of respective entities based on the one or more keywords being associated with respective entity parameters, as described above in connection with reference number 130, reference number 135, reference number 140, and/or reference number 145 of FIG. 1B. As an example, the model management device 210 may modify the input to cause a keyword to be indicative of an entity based on the keyword being associated with, or mapped to, an entity parameter that is associated with the entity. As another example, the model management device 210 may modify the input to cause a keyword to modified to be indicative of information associated with another modification parameter described herein.

As further shown in FIG. 4, process 400 may include providing, based on receiving the input, the output for display (block 430). For example, the model management device 210 (e.g., using processor 320 and/or memory 330) may provide, based on receiving the input, the output for display, as described above in connection with reference number 150 of FIG. 1C. In some implementations, the output includes visual elements, associated with respective keywords of the one or more keywords, that indicate the respective entities.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for modifying inputs for an artificial intelligence model, the system comprising:
one or more memories; and
one or more processors, communicatively coupled to the one or more memories, configured to:
receive, via a user device, an input requesting a visual media output;
determine one or more keywords included in the input;
identify, for at least one keyword of the one or more keywords, an association between the at least one keyword and an entity parameter,
wherein the entity parameter is indicative of an entity;
modify, based on the association, the input to create a modified input,
wherein the modified input includes a modification to the at least one keyword to cause the at least one keyword to be indicative of the entity;
provide, to the artificial intelligence model, the modified input;
obtain, via the artificial intelligence model and based on providing the modified input, the visual media output; and
provide, to the user device, the visual media output for display.

2. The system of claim 1, wherein the one or more processors, to identify the association, are configured to:
search, using the at least on keyword, an entity database to identify the entity parameter.

3. The system of claim 1, wherein the one or more processors are further configured to:
determine, via a natural language processing operation, a first semantic meaning associated with the input, and
wherein the one or more processors, to modify the input, are configured to:
determine, via the natural language processing operation, a second semantic meaning associated with the modified input; and
determine a similarity metric indicating a similarity between the first semantic meaning and the second semantic meaning,
wherein providing the modified input is based on the similarity metric satisfying a similarity threshold.

4. The system of claim 1, wherein the one or more processors, to identify the association, are configured to:
determine a category associated with the at least one keyword,
wherein the association is between the category and the entity parameter.

5. The system of claim 1, wherein the one or more processors, to modify the input, are configured to:
determine, based on the input, whether the at least one keyword is modified by an entity modifier in the input,
wherein modifying the input is based on the at least one keyword not being modified by the entity modifier in the input.

6. The system of claim 1, wherein, based on the modified input, the visual media output includes at least one visual element that visually indicates that the at least one visual element is associated with the entity,
wherein the at least one keyword indicates the at least one visual element.

7. The system of claim 1, wherein the one or more processors, to identify the association, are configured to:
determine, for the at least one keyword, a set of entity parameters associated with the at least one keyword;
determine entity scores for respective entity parameters from the set of entity parameters; and
determine that the at least one keyword is associated with the entity parameter based on an entity score associated with the entity parameter being a highest entity score among the entity scores.

8. A method of modifying inputs for an artificial intelligence model, comprising:
receiving, by a device, an input for the artificial intelligence model,
wherein the input describes an output of the artificial intelligence model;
generating, by the device and via the artificial intelligence model, the output based on a modified input that is based on modifying one or more keywords included in the input to be indicative of respective entities based on the one or more keywords being associated with respective entity parameters; and
providing, by the device and based on receiving the input, the output for display,
wherein the output includes visual elements, associated with respective keywords of the one or more keywords, that indicate the respective entities.

9. The method of claim 8, wherein generating the output comprises:
modifying the input to the modified input based on modifying the one or more keywords to be indicative of the respective entities;
providing, to the artificial intelligence model, the modified input; and
obtaining, from the artificial intelligence model, the output.

10. The method of claim 8, wherein generating the output comprises:
providing, to the artificial intelligence model, the input; and
obtaining, from the artificial intelligence model, the output that is based on the modified input.

11. The method of claim 10, further comprising:
providing, to the artificial intelligence model, an indication of associations between keywords and entity parameters to train the artificial intelligence model to modify inputs based on the associations.

12. The method of claim 8, further comprising:
parsing, using a natural language processing operation, the input to identify a set of keywords; and
identifying the one or more keywords from the set of keywords based on the one or more keywords being associated with the respective entity parameters.

13. The method of claim 12, wherein identifying the one or more keywords is based on the one or more keywords not being modified by entity modifiers in the input.

14. The method of claim 8, wherein the visual elements are visually indicative of the respective entities.

15. The method of claim 8, further comprising:
determining, for a keyword of the one or more keywords, a set of entity parameters associated with the keyword;
determining entity scores for the respective entity parameters; and
determining that the keyword is associated with an entity parameter based on an entity score associated with the entity parameter being a highest entity score among the entity scores.

16. A non-transitory computer-readable medium storing a set of instructions, the set of instructions comprising:
one or more instructions that, when executed by one or more processors of a device, cause the device to:
receive an input requesting a visual media output;
determine one or more keywords included in the input;
identify, for at least one keyword of the one or more keywords, an association between the at least one keyword and an entity parameter,
wherein the entity parameter is indicative of an entity;
modify, based on the association, the input to a modified input,
wherein the modified input includes a modification to the at least one keyword to cause the at least one keyword to be indicative of the entity;
provide, to an artificial intelligence model, the modified input;
obtain, via the artificial intelligence model and based on providing the modified input, the visual media output; and
provide the visual media output for display.

17. The non-transitory computer-readable medium of claim Error! Reference source not found., wherein the one or more instructions, that cause the device to identify the association, cause the device to:
search, using the at least on keyword, an entity database to identify the entity parameter.

18. The non-transitory computer-readable medium of claim Error! Reference source not found., wherein the one or more instructions further cause the device to:
determine, via a natural language processing operation, a first semantic meaning associated with the input, and
wherein the one or more instructions, that cause the device to modify the input, cause the device to:
determine via the natural language processing operation, a second semantic meaning associated with the input; and
determine a similarity metric indicating a similarity between the first semantic meaning and the second semantic meaning,
wherein providing the modified input is based on the similarity metric satisfying a similarity threshold.

19. The non-transitory computer-readable medium of claim Error! Reference source not found., wherein the one or more instructions, that cause the device to modify the input, cause the device to:
determine, based on the input, whether the at least one keyword is modified by an entity modifier in the input,
wherein modifying the input is based on the at least one keyword not being modified by the entity modifier in the input.

20. The non-transitory computer-readable medium of claim Error! Reference source not found., wherein, based on the modified input, the visual media output includes at least one visual element that visually indicates that the at least one visual element is associated with the entity,
wherein the at least one keyword indicates the at least one visual element.
